(19) United States
(12) Patent Application Publication
(10) Pub. No.: US 2006/0277765 A1
(43) Pub. Date: Dec. 14, 2006

(54) Tool with modified box joint and mehod of making thereof

(76) Inventor: Roger Kaye, Fort Ann, NY (US)

Correspondence Address: Roger Kaye, 471 Clayhill Road, P.O. Box 210, Fort Ann, NY, 12877, US

(21) Appl. No.: 11/150,719

(22) Filed: Jun. 10, 2005

(51) Int. Cl. B26B 17/00

(52) U.S. Cl. 30/266; 30/28; 30/193

(57) ABSTRACT

The method employs attaching two handle/jaw pieces together with a third coverplate piece thereon in the hinge area so that a flange surface of the coverplate opposes a flange surface of one of the handles. A flange surface on the second handle similarly opposes a second flange surface of the first handle. These opposing flange surfaces together creates a type of modified box joint that is robust, accurate, and capable of simple disassembly. A joint in combination with a hand tool that employs this method.

### FIELD OF INVENTION

This invention relates generally to the field of hand tool manufacturing. More particularly, the invention relates to a tool, such as a cuticle nipper, with a unique modified box joint system and a method of making the same.

### BACKGROUND OF INVENTION

Current methods for making hand tools typically entail either the use of a lap joint or a box joint for the joint system between the opposing handle elements.

The term hand tool herein includes any manual, or semi-manual, tool that has two counteracting arms that rotate about an axis, or pin. In no way is the example meant to limit the definition, but an example of the type of hand tools herein include cuticle nippers and the like.

In constructing a tool with a lap joint, the two handle/jaw pieces of the nipper are placed over each other so as to line up the hinging holes therein. A pin in driven through the two aligned hinging holes. The end of the pin is then peened over (e.g., struck with a force). The peened pin end(s) are then ground smooth so as to be relatively camouflaged on the outside of the joint. The nipper cutting jaw edges may then be hand sharpened and finished.

Contrastingly, in box joint construction, one of the two forged handle/jaw pieces has a “box”-type construct, that has a drilled or milled slot in it. The slot area of the box is heated and then expanded by driving a mandril through it. The second handle/jaw/blade piece is then inserted through this expanded, heated opening of the box. The opening is then beaten closed (e.g., struck with a force) locking together the two handle elements. A pin similarly is placed through the aligned holes; then peened to adjust tension; and ground as in the lap jaw. The nipper cutting jaw edges are then hand sharpened and finished.

Both lap joints and box joints have their inherent advantages and disadvantages.

Clearly, the lap joint is easier and cheaper to manufacture. The box joint is more robust, however. Both joint constructs with their overall manufacturing methods, including the peening and the heating and use of the mandril, result in free play between the jaws which then leads to undesirable “scissoring” of the jaws. Ultimately, neither joint is able to be easily and accurately sharpened and/or resharpened. Adjustment and/or readjustment of the tool and cleaning are also impracticable. The overall quality control of the resultant nipper, with either joint construction, is suspect.

Accordingly, there is a need in the field of hand tool manufacturing for an improved joint design and a method of making the same that offers advantages over the prior art joint construction types.

### SUMMARY OF INVENTION

The present invention provides an improved type ofjoint for use on hand tools, and the tool and methods of employing the same.

A first general aspect of the invention provides a method of making a jawed hand tool, the steps comprising:

providing a first element having a first jaw distal to a first handle and a first flange surface therebetween;

providing a second element having a second jaw distal to a second handle and a second flange surface and a third flange surface therebetween, further wherein said second flange surface and third flange surface are on opposing sides of said second element;

providing a third element having a fourth flange surface;

rotatably attaching said second element between said first element and said third element so that said first flange surface abuts said second flange surface and said third flange surface abuts said fourth flange surface, further wherein said first jaw and said second jaw oppose each other.

A second general aspect of the invention provides a hinged joint in combination with a hand tool comprising:

two elements rotatably attached together at said hinged joint to form a nipper, each element comprising a jaw distal to a handle; and

said hinged joint comprising four flange surfaces wherein a first flange surface on said first element faces a second flange surface on said second element and a joint cover having a fourth flange surface faces a third flange surface on said second element, further wherein said second flange surface and said third flange surface are on opposing sides of said second element, further wherein said joint cover is removably attached to said first element.

The foregoing and other features of the invention will be apparent from the following more particular description of various embodiments of the invention.

### BRIEF DESCRIPTION OF DRAWINGS

Some of the embodiments of this invention will be described in detail, with reference to the following figures, wherein like designations denote like members, wherein:

FIG. 1 depicts an exploded top, perspective view of an embodiment of hand tool, in accordance with the present invention;

FIG. 2 depicts a close up, top view of the jaws and modified box joint portion of an embodiment of a hand tool, in accordance with the present invention;

FIG. 3A depicts a close-up side view of a first jaw of an embodiment of a hand tool, in accordance with the present invention;

FIG. 3B depicts a close-up side view of a second jaw of an embodiment of a hand tool, in accordance with the present invention;

FIG. 4 depicts a close-up side view of the jaws and modified box joint portion of an embodiment of a hand tool, in accordance with the present invention; and

FIG. 5 depicts a close-up sectional elevation view of the modified box joint portion of an embodiment of a hand tool, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. Although the drawings are intended to illustrate the present invention, the drawings are not necessarily drawn to scale.

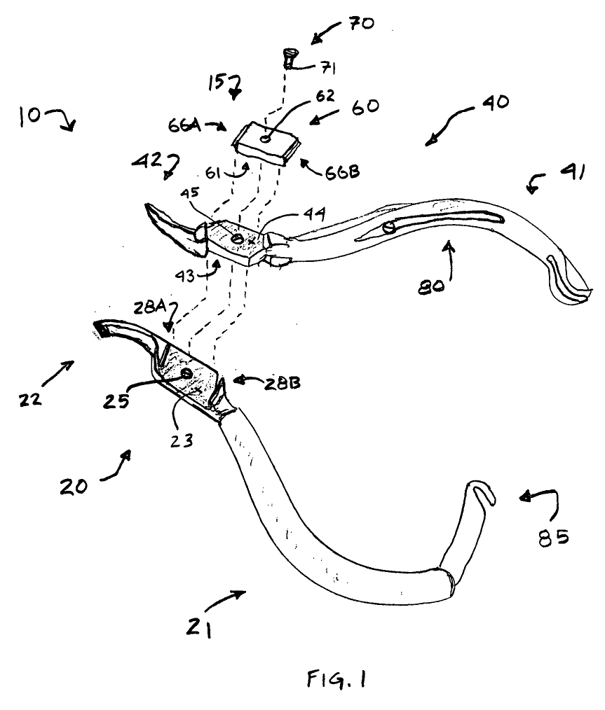

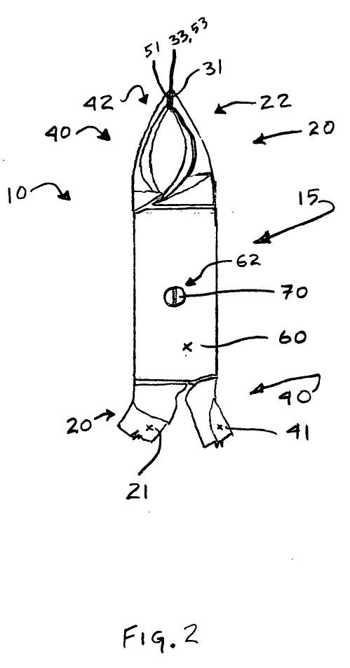

Turning to the figures, an exploded perspective view of an embodiment of the invention, is depicted in FIG. 1, while FIGS. 2-4 show various close-up views of details of the invention.

FIG. 1 shows an exploded view, in perspective, of an embodiment of a hand tool, denoted with a 10, employing the aspects of the present invention. The hand tool 10 in this preferred embodiment is a nipper, or cuticle cutter. It should be noted that the invention may be employed in other hand tools that use opposing handles and jaws with a pivoting hinge. For example, pliers, scissors, wire cutters, bolt cutters, and the like.

The tool 10 includes a first element 20, a second element 40, and a third element 60. The modified box joint 15 of the present invention is located essentially in the hinge, or joint, area of the tool 10. The joint 15 is located between a jaw 22 of the first element 20, a jaw 42 of the second element 40, and a handle 21 of the first element 20 and a handle 41 of the second element 40.

The first element 20 includes a jaw 22 and a handle 21. Between the jaw 22 and handle 21 is a hinge area. Part of the hinge area includes a first flange face 23 with a hole 25 therethrough. The hole 25 may include threads 25 for receiving threads 72 on a screw 70. The first flange face 23 may be ground, cut, or milled substantially flat.

Optionally, there may be a hinged locking element 85 for locking the first element 20 and second element 40 together during non-use.

Similarly, the second element 40 includes a jaw 42 and a handle 41. Between the jaw 42 and the handle 41 is a hinge area. Part of the hinge area includes a second flange face 43 and an opposed third flange face 44 with a hole 45 therethrough. The second and third flange faces 43, 44 may be ground, cut, or milled substantially flat.

Optionally, there may be a spring means 80 for providing a spring bias between the two elements 20, 40 during use. The spring means 80 may be a rotatably leaf spring (see FIG. 1), a coil spring, or similar spring types located at the joint 15 or other areas of the tool 10 that provides a spring bias to the jaws 22, 42 for opening.

A third element 50 includes a fourth flange face 61 with a hole 62 therethrough. The third element 50 functionally acts, in some aspects, as a joint cover.

As FIG. 1 depicts the first and second elements 20, 40 are placed over each other so that the first flange face 23 and the second flange face 42 abut. Similarly, the third element 60 is placed over the second element 40 so that the third flange face 43 and the fourth flange face 61 similarly abut. The term abut means that the faces oppose each other and are adjacent. They need not contact each other. A pin 70 is placed to its shank 72 goes through the various holes 62, 45, 25. The pin 70 may be a screw with threads 71 wherein corresponding threads 26 located on the hole 25 through the first flange face 23. The pin 70 serves as a hinge pin, of sorts, to allow for rotation of the elements 20, 40 around the pin 70.

Alternatively, the pin 70 may be a bolt (not shown) with a corresponding nut (not shown) that provides a similar rotating capability to the tool 10.

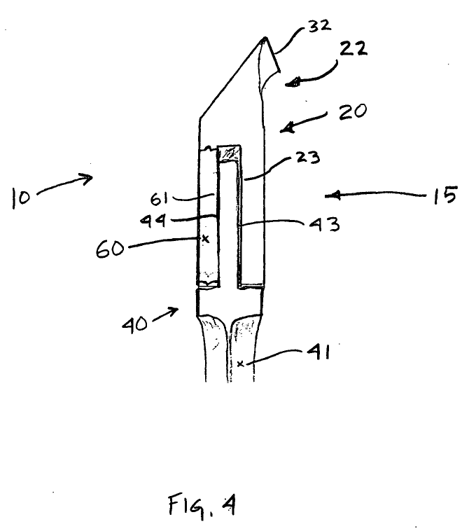

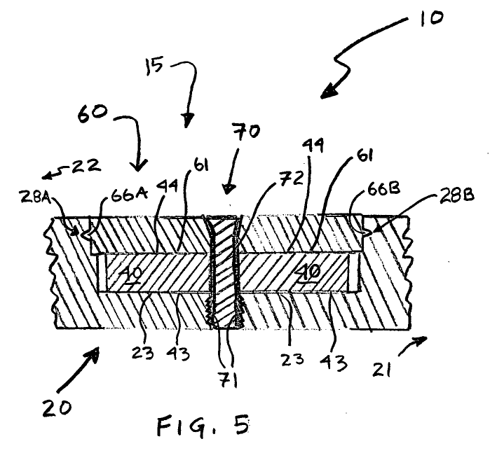

As the sectional view close up in FIG. 5 and the close up view in FIG. 4 show more apparently, the third element 60 and the first element 20 may include corresponding configurations that provide added strength to the joint 15 once completed. For example, the first element 20 may include at least one recess 28A, 28B that match is size and shape at least one projection 66A, 66B located on the periphery of the third element 60. In this manner, the third element 60 may be slid horizontally into place over the second element 40 so that the projections 66A, 66B slid into the recesses 28A, 28B. Once then the pin 70 is placed, and if applicable, tightened, the recesses 28A, 28B provide a location for increased purchase for the third element 60 to the first element 20, via the projections 66A, 66B. Alternative types and shapes of means for increasing this purchase between the third element 60 and first element 20 may be used. For example, detents, keys, keyways, and the like can be used. Alternatively, the end of the third element 60 may be substantially smooth, or unadulterated with any structural purchasing enhancements. That is the third element 60 may be placed on top of the first element 20 so that the third element 60 simply abuts and aligns with portions of the first element 20. The placement will allow free rotation of the second element 40 between the first element 20 and third element 60 (and vice versa). In whatever embodiment that is employed, as a result, when the pin 70 is placed, the first and third element 20, 60 effectively act as a monolithic joint construct (i.e., modified box joint) around the second element 40 that is robust, strong, prevents scissoring of the jaws 22, 42 and, yet, is readily able to be disassembled.

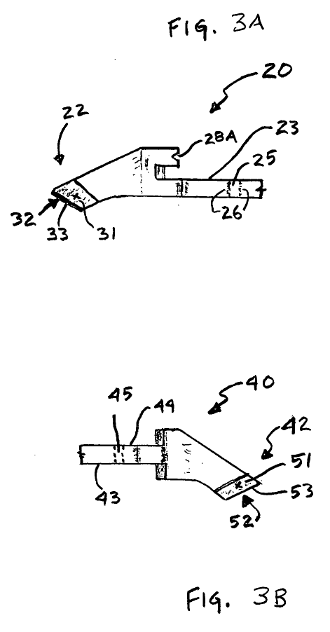

FIGS. 2, 3A, and 3B, in particular, show close up view of the jaws 22, 42 and their interplay. The jaw 22 on the first element 20 includes an interior jaw face 31 and an exterior jaw face 32 and a jaw edge 33 that is formed between the two (See FIG. 3A). Similarly, the jaw 42 on the second element 40 includes an interior jaw face 51 and an exterior jaw face 52 and a jaw edge 53 that is formed between the two (See FIG. 3B).

As FIG. 2 shows, the interior jaw faces 31, 51 lined up and face each other and abut when the jaws 22, 42 of the tool are closed. Similarly, the exterior jaw faces 32, 52 line up, when the jaws 22, 42 are closed, so that they form essentially a co-planar surface.

The uniformity in the construction of the various flange faces 23, 43, 44, 61 provides for a high quality tool that has limited, or no, susceptibility to scissoring of the jaws over time. That is the interior jaw faces 31, 51 lined and match each other when the jaws are closed 22, 42. The flange faces 23, 43, 44, 61 also provide for an excellent “datum”, or attachment, surface for sharpening, cleaning, and the like, of the various parts of the elements 20, 40 either prior to construction, or after use.

For example, the tool 10 can be placed on the material handling device, patented by this same inventor, under U.S. Pat. No. 6,821,193, incorporated herein by reference in its entirety, for sharpening or other material handling (e.g., buffing, etc.). For example, the tool 10 could be taken apart and the first element 20 can be placed and clamped on the table of the handling device for subsequent sharpening. Similarly, the second element 40 can be sharpened at the device via similar methods and means.

Note that the FIGs. throughout depicts flange faces 23, 43, 44, 61 that are substantially smooth. That is the faces 23, 43, 44, 61 may be ground or cut smooth after manufacture, or forged with smooth faces 23, 43, 44, 51 during manufacture. Alternatively, the faces 23, 43, 44, 61 need not be an entirely smooth face. The faces 23, 43, 44, 61 may, for example, have various depressions, projections, keying, detents, and the like (not shown), that would still allow for suitable rotation of the first and second elements 20, 40. If employed, the use of any of these types of enhancements may further assist in the tracking of the elements 20, 40 as they rotate about the joint 15 so as to minimize scissoring of the jaws 22, 42 and maximize the utility of the tool 10.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

1. A method of making a jawed hand tool, the steps comprising:
providing a first element having a first jaw distal to a first handle and a first flange surface therebetween;
providing a second element having a second jaw distal to a second handle and a second flange surface and a third flange surface therebetween, further wherein said second flange surface and third flange surface are on opposing sides of said second element;
providing a third element having a fourth flange surface; and
rotatably attaching said second element between said first element and said third element so that said first flange surface abuts said second flange surface and said third flange surface abuts said fourth flange surface, further wherein said first jaw and said second jaw oppose each other.

2. The method of claim 1, wherein said rotatable attaching is via a pin.

3. The method of claim 2, wherein said pin is threaded.

4. The method of claim 1, further comprising:
inserting a pin through said first flange surface, said second flange surface, said third flange surface, and said fourth flange surface so as to join said third element and said first element to said second element.

5. The method of claim 1, wherein at least one of said first, second, third, and fourth flange surface is substantially smooth.

6. The method of claim 1, wherein said first jaw and said second jaw form cutting jaws.

7. The method of claim 1, further comprising:
attaching a spring bias means between said first element and said second element.

8. The method of claim 1, further wherein said third element includes at least one projection adapted to interact with at least one depression on said first element, so as to enhance the purchase between said third element and said first element.

9. The method of claim 1, further comprising removably attaching said third element to said first element.

10. The method of claim 9, further wherein said third element includes a means for attaching to said first element that said first element and said third element combine together to a substantially monolithic construct.

11. A hinged joint in combination with a hand tool comprising:
two elements rotatably attached together at said hinged joint to form a nipper, each element comprising a jaw distal to a handle; and
said hinged joint comprising four flange surfaces wherein a first flange surface on said first element faces a second flange surface on said second element and a joint cover having a fourth flange surface faces a third flange surface on said second element, further wherein said second flange surface and said third flange surface are on opposing sides of said second element, further wherein said joint cover is removably attached to said joint.

12. The joint in combination with the hand tool of claim 11, wherein said joint cover is removably attached to said first element.

13. The joint in combination with the hand tool of claim 11, wherein said joint cover engages with said first element.

14. A method of making an apparatus comprising:
providing a first element having a handle and a distally located jaw element with a first hinge area therebetween;
providing a second element having a handle and a distally located jaw element with a second hinge area therebetween; and
attaching a cover plate to said first hinge area, so that said second hinge area is between said first hinge area and said cover plate, so that said cover plate and said first hinge area act as a box joint around said second hinge area; and
rotatably connecting said first hinge area to said second hinge area via a pin, so that said two jaw elements act in concert upon the closing and opening of said two handles.

15. The method of claim 14, wherein said cover plate is removably attached to said first hinge area.
